(19) United States
(12) Patent Application Publication
(10) Pub. No.: US 2025/0386799 A1
(43) Pub. Date: Dec. 25, 2025

(54) Animal Bathing and Grooming Glove and Grooming Method

(71) Applicant: Suhong ZHANG, Zhejiang (CN)

(72) Inventor: Suhong ZHANG, Zhejiang (CN)

(21) Appl. No.: 18/747,443

(22) Filed: Jun. 19, 2024

(51) Int. Cl. A01K 13/00; A41D 19/00; A45D 24/28

(52) U.S. Cl. CPC A01K 13/002; A41D 19/0024; A45D 24/28

(57) ABSTRACT

An animal bathing and grooming glove and a novel grooming method. The animal bathing and grooming glove comprises a glove body, wherein the glove body is provided with at least one cleaning surface, and a comb tooth part is arranged on the cleaning surface; the glove body is provided with a protruding device, and the protruding device is provided with a spraying part for spraying the area facing the cleaning surface; and a water storage cavity for supplying water to the spraying part, a circuit board and a control switch for controlling the spraying part to operate are arranged in the protruding device.

### TECHNICAL FIELD

The present application relates to the technical field of pet articles, in particular to a novel animal bathing and grooming glove and a novel grooming method.

### BACKGROUND

In the daily activities of pet care, grooming is a crucial job. It not only contributes to the health of pet hair, but also promotes the emotional communication between pets and their owners.

Traditional grooming gloves are often inefficient when dealing with knotted or messy hair, which tends to fly around, and may cause discomfort to animals, and it is likely to generate static electricity, resulting in unkempt hair and difficult to comb. For example, the carding gloves disclosed in U.S. Pat. No. 11,985,643 and No. 17570124 have the above problems.

Based on this, it is necessary to put forward an animal bathing and grooming glove, which makes hair smoother, easier to comb and improves grooming efficiency.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present application provides an animal bathing and grooming gloves, which includes a glove body, wherein the glove body has at least one cleaning surface, and the cleaning surface is provided with comb tooth parts;
the glove body is provided with a protruding device, and the protruding device is provided with a spraying part for spraying an area facing the cleaning surface;
and a water storage cavity for supplying water to the spraying part, a circuit board and a control switch for controlling operation of the spraying part are arranged in the protruding device.

The present application further provides an animal bathing and grooming glove, which includes a glove body, wherein the glove body has at least one cleaning surface, and the cleaning surface is provided with a comb tooth part with comb teeth and a spraying port, and the glove body is provided with a protruding device, wherein the protruding device is provided with a water storage cavity, a spraying part communicated with the water storage cavity, a battery pack for supplying energy to the spraying part, a circuit board and a control switch for controlling the operation of the spraying part; the spraying part is communicated with the spraying port to form a spraying channel, and the spraying port sprays to an area facing the cleaning surface; the protruding device is provided with a water injection port which can be connected with a water pipe, and the water injection port is communicated with the water storage cavity.

The present application further provides a novel grooming method, which includes the following steps:
providing an apparatus, which includes a glove body, wherein the glove body is provided with at least one cleaning surface, and a comb tooth part is arranged on the cleaning surface;
the glove body is provided with a protruding device, and the protruding device is provided with a spraying part for spraying an area facing the cleaning surface, and a water storage cavity for supplying water to the spraying part, a circuit board and a control switch for controlling the spraying part to work are arranged in the protruding device;
the method includes the following steps:
wearing the glove body and choosing the cleaning surface on the glove body for cleaning;
opening the spraying part through the control switch on the glove body;
grooming the area facing the cleaning surface by the comb tooth part; and
atomizing, humidifying and cleaning the area facing the cleaning surface by the spraying part.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic view of the palm part of an animal bathing and grooming glove;

FIG. 2 is a schematic view of the hand back part of the animal bathing and grooming glove;

FIG. 3 is a side view of the animal bathing and grooming glove;

FIG. 4 is a schematic view of the inside of the protruding device;

FIG. 5 is another schematic diagram of the hand back part of the animal bathing and grooming glove;

FIG. 6 is another schematic diagram of the hand back part of the animal bathing and grooming glove;

FIG. 7 is another schematic diagram of the comb tooth shape of the animal bathing and grooming glove;

FIG. 8 is another schematic diagram of the comb tooth shape of the animal bathing and grooming glove.

In the figures:
Glove body (1000); Comb tooth part (1001); Comb tooth (1002); Protruding device (1100); Water storage cavity (1101); Atomizing component (1102); Spraying pipe (1104); Control chamber (1105); Circuit board (1106); Battery pack (1107); Charging port (1108); Spraying port (1109); Water injection port (1110); Control switch (1111); Cover (1112); Cleaning surface (1200); Wrist part (1300); Strap (1301); Hook and loop (1302).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other

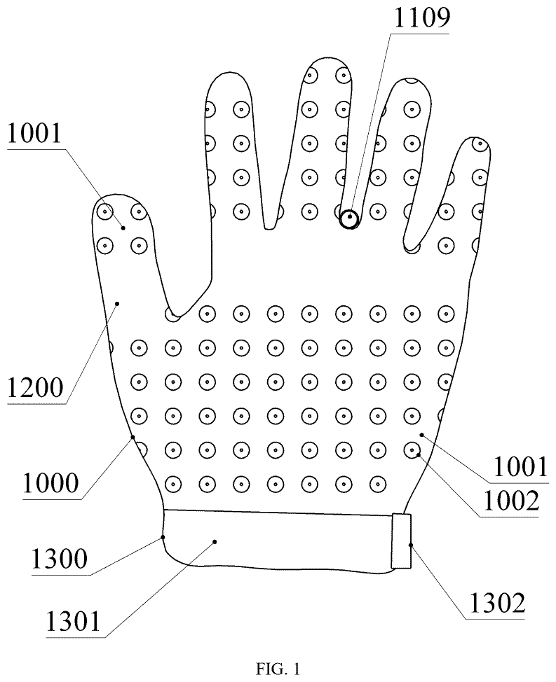

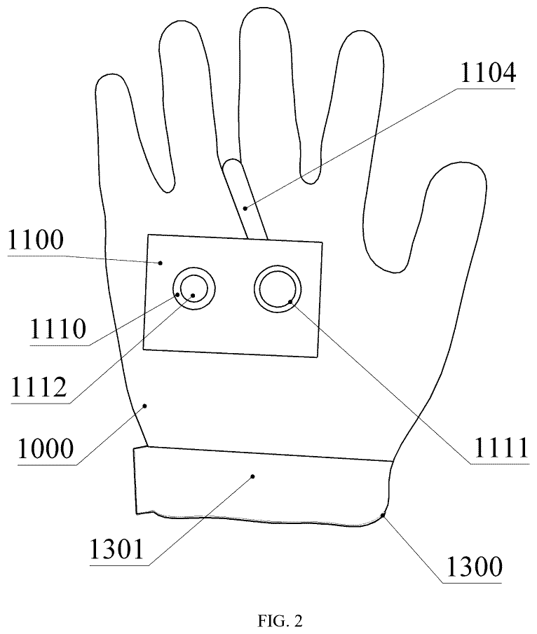

As shown in FIGS. 1 to 4, the present application provides an animal bathing and grooming gloves, which comprises a glove body 1000, wherein the glove body 1000 has at least one cleaning surface 1200, and the cleaning surface 1200 is provided with a comb tooth part 1001;

the glove body 1000 is provided with a protruding device 1100, and the protruding device 1100 is provided with a spraying part for spraying the area facing the cleaning surface 1200; the protruding device 1100 is provided with a water storage cavity 1101 for supplying water to the spraying part, a circuit board 1106 for controlling the operation of the spraying part and a control switch 1111.

The glove body 1000 includes a palm part, a hand back part and a wrist part 1300. In this embodiment, one side of the palm part is selected as the cleaning surface 1200, and the protruding device 1100 is arranged on the hand back part, and the protruding device 1100 and the hand back part are connected by an adhesive, so that the glove can be ensured to be compact in structure and not affect the grooming operation. The wrist part 1300 is provided with a strap 1301, which encircles the wrist part 1300 in one circle, and the end of the strap 1301 is provided with a hook and loop 1302. Besides the hook and loop 1302, the wrist part 1300 can be restrained by means of an elastic beam opening and the like. In other embodiments (not shown in the figure), the cleaning surface 1200 is not limited to the palm part, and the protruding device 1100 is not limited to the hand back part, and can also be set at any desired position.

In this embodiment, the animal bathing and grooming glove is made of waterproof and durable materials to ensure the waterproofness and durability of users during use, and the glove body is internally provided with an anti-slip design that fits the palm part of the hand to ensure that the gloves will not slip when grooming the pet hair.

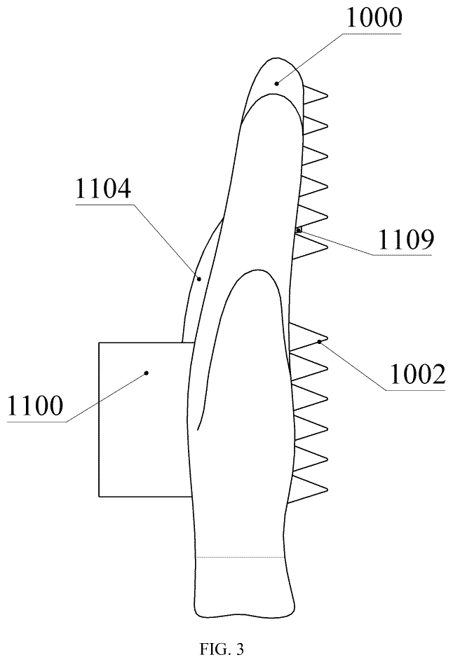

The comb tooth parts 1001 are integrally formed or detachably connected with the glove body 1000. In this embodiment, rubber comb teeth are embedded in the glove body 1000, so that the comb tooth part 1001 will become a part of the glove without additional connection. As shown in FIG. 3, the comb tooth parts 1001 are integrally formed with the glove body 1000, and the comb tooth parts 1001 are arranged on the palm part area and the finger area of the palm part. In other embodiments (not shown in the figure), an elastic strap is arranged on the hand back of the glove body 1000 to fix the comb tooth part 1001 on the glove, so that the user can adjust the position of the comb tooth part as required. In addition, the detachable connection modes of the comb tooth part 1001 and the glove body 1000 include: zipper connection, which connects the comb tooth part 1001 with the glove body 1000, and users only need to pull the zipper to remove the comb tooth part 1001; clasp and notch connection, in which a clasp and a notch are respectively arranged on the comb tooth part 1001 of the glove body 1000 and the glove, and in this way, the comb tooth parts can be easily inserted and detached, similar to the design of buttons; magnetic connection, which is used between the comb tooth part 1001 and the glove body 1000, and this design can ensure that the comb tooth parts are tightly fixed on the glove, and it is convenient for users to disassemble; snapper connection, in which snappers are arranged on the comb tooth part 1001 and the glove body 1000, and users only need to press the snappers to easily remove the comb tooth parts; threaded connection, in which threads are provided on the comb tooth part 1001 and the glove body 1000, and users can rotate the comb tooth parts to tighten or disassemble them. Through the detachable connection, after the grooming work is completed, the comb tooth parts 1001 can be detached for separate cleaning, which is more convenient than when it is integrally connected with the glove body 1000 for cleaning.

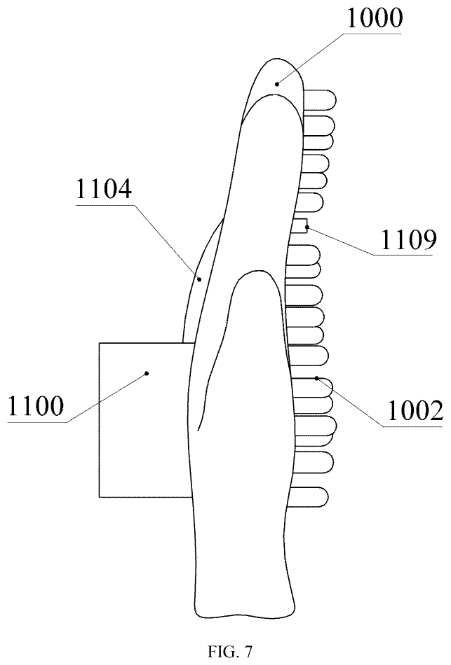

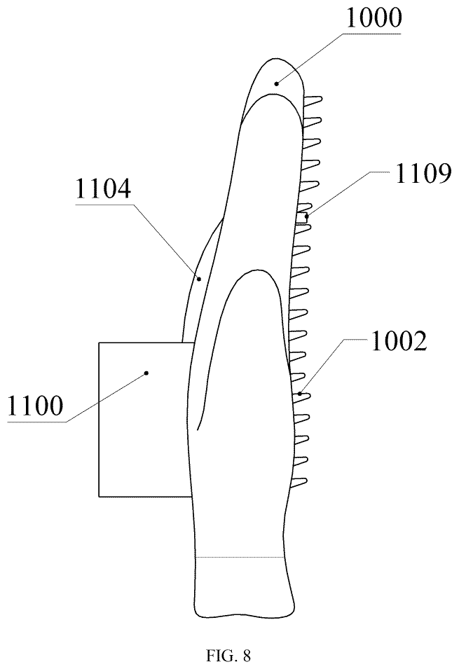

A plurality of comb teeth 1002 formed by grooming protrusions are convexly arranged on the comb tooth part 1001, and these comb teeth 1002 are made of soft and elastic materials, which can gently comb the hair of pets and avoid causing irritation or injury to the skin of pets. The shape and arrangement of the comb teeth 1002 can be set in any desired way. As shown in FIGS. 7 and 8, the shape of the comb teeth 1002 can be designed in the form of a thick oval head or a short head. In other embodiments (not shown in the figure), the shape of the comb teeth 1002 can also be designed as a wave shape, which can better capture the hair of the pet and reduce the irritation to the skin of the pet; V-shaped comb teeth, which can better comb the hair of long-haired pets and make it smoother; S-shaped comb tooth part, comb teeth 1002 are designed in an S-shaped comb teeth, and this design can better capture the pet's hair and reduce the irritation to the pet's skin; bent comb teeth, and the shape of the comb teeth 1002 can be designed in a curved form, and such comb teeth are more suitable for pets with curly hair; spherical comb teeth, which can comb the pet's hair more gently, while ensuring that it will not irritate the pet's skin, thereby further reducing the irritation to pets, effectively removing lumps and impurities in pet hair by setting reasonable ones, promoting the blood circulation of pet skin and enhancing the comfort of pets.

In other embodiments (not shown in the figure), the comb teeth 1002 are staggered: the comb teeth 1002 are staggered, similar to the shape of a gear, so that the pet's hair can be combed more evenly to ensure that there are no missing areas; or asymmetrical arrangement: the comb teeth 1002 are not arranged symmetrically according to rules, but are arranged randomly or irregularly, and this design can increase the diversity of grooming and adapt to the needs of different parts. When the comb tooth part 1001 is detachable from the glove body 1000, it is also designed as adjustable comb tooth: consider designing an adjustable comb tooth system that allows users to adjust according to the hair type and thickness of pets, so that users can customize the arrangement of comb tooth part.

The spraying part comprises a spraying pipe 1104, an atomizing component 1102 and a spraying port 1109, wherein the spraying pipe 1104 is communicated with the water storage cavity 1101 and penetrates to the cleaning surface 1200 along the surface of the glove body 1000; the spraying port 1109 is arranged at one end of the spraying pipe 1104 far away from the water storage cavity 1101, and the spraying port 1109 sprays the area facing the cleaning surface 1200, and the water storage cavity 1101 continuously supplies water to the spraying part by means of cotton swab, etc., so as to keep the atomizing component 1102 moist for atomization.

The atomizing component 1102 is a key assembly in the animal bathing and grooming glove. It is a device that realizes spraying by converting liquid into fine granular suspended matter. By pushing the liquid to generate fine particles through heating or vibration, the liquid is converted into atomized substances, which are guided to spraying port 1109 by the spraying pipe 1104 and sprayed. The common atomizer principles in the atomizing component 1102 include thermal atomization and ultrasonic atomization. The thermal atomizer uses a heating element to raise the temperature of the liquid, so that it can be rapidly vaporized into a mist. The heating element can be a heating coil, a ceramic hot plate, a metal mesh, etc. When the liquid comes into contact with the heating element, the liquid quickly heats up and is transformed into a mist, and then it is released; the ultrasonic atomizer uses the vibration of high-frequency ultrasonic to atomize liquid. Under the action of ultrasonic waves, the liquid produces high-frequency vibration, forming fine ripples on the surface of the liquid. These ripples break quickly, breaking the liquid into tiny particles and forming mist. The shape and size of the atomizing component 1102 are precisely designed to ensure that it can work stably in the atomizing part and generate enough water mist.

Compared with directly spraying water and humidifying with a water spraying mechanism on the glove, the effect of spraying water mist is less irritating to pets, which reduces the possibility of pet stress reaction when cleaning and nursing pets, and the water mist will not make pet hair too wet and can be quickly dried after cleaning.

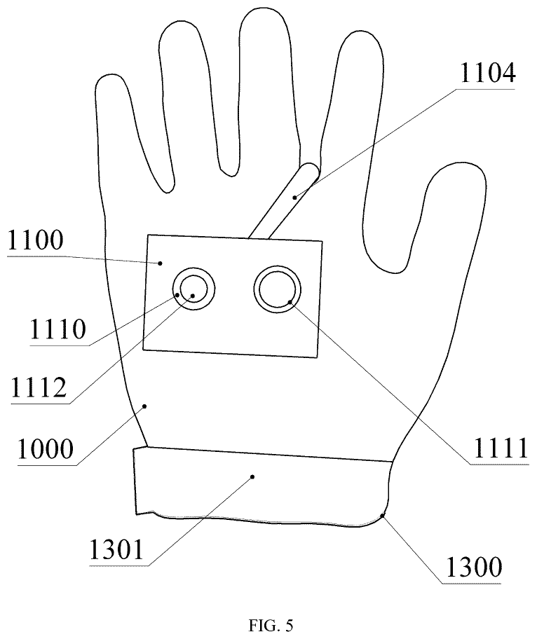

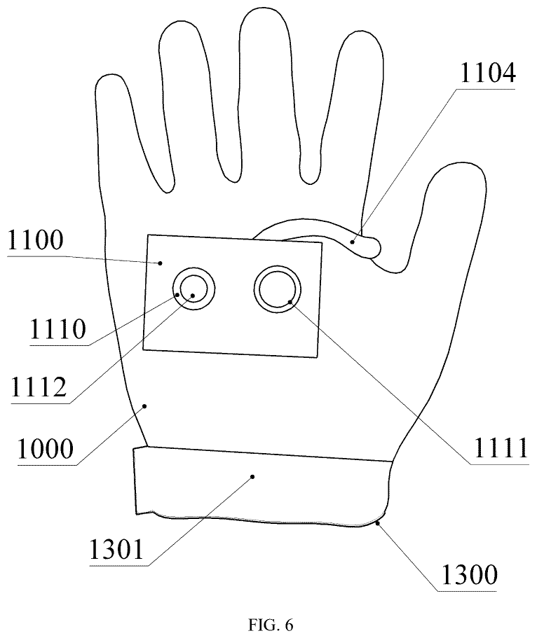

As shown in FIG. 1, the glove body 1000 has a closed five-finger structure, and the spraying port 1109 can be realized by using a nozzle with a connector or directly in the form of a port of a spraying pipe 1104. The spraying port 1109 is arranged at the position between the fingers of the glove body 1000. In this embodiment, the spraying port 1109 is arranged at the position between the middle finger and the ring finger, which is convenient to use. As shown in FIG. 5 and FIG. 6, in other embodiments, the spraying port 1109 is not limited to the position between the middle finger and the ring finger, nor is it limited to the position between the five fingers of the glove body 1000, but can also be set at any desired position, such as between the comb teeth 1002 at the palm part.

The water mist generated by the atomizing component 1102 can moisten the hair and skin of the pet, and effectively relieve the discomfort of the pet during grooming. At the same time, the cool feeling of water mist can also bring a pleasant experience to pets, so that pets can enjoy the grooming process more. The animal bathing and grooming glove integrates the functions of grooming and water mist moisturizing, and can meet the needs of pets grooming without carrying other tools. At the same time, the portability and ease of use of the glove also enable users to provide grooming services for pets anytime and anywhere.

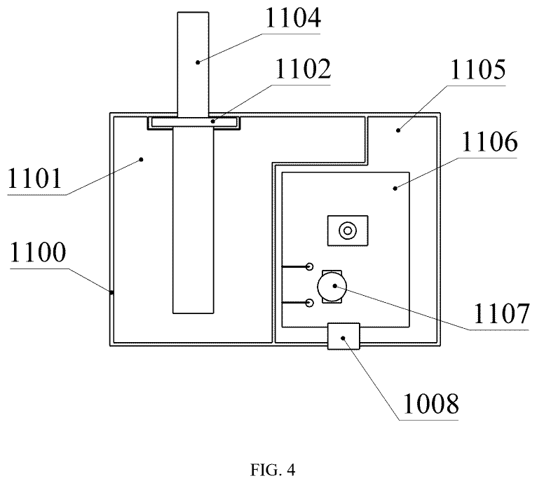

In this embodiment, as shown in FIG. 4, a protruding device 1100 is provided with a water storage cavity 1101, a spraying part communicating with the water storage cavity 1101, a battery pack 1107 for supplying energy to the spraying part, a circuit board 1106 and a control switch 1111 for controlling the operation of the spraying part; a control chamber 1105 is formed in the protruding device 1100, and the battery pack 1107 and the circuit board 1106 are arranged in the control chamber 1105. The circuit board 1106 is electrically connected with the spraying part, and the control switch 1111 is embedded on the outer wall of the protruding device 1100 and electrically connected with the circuit board 1106. Specifically, a mechanical button is arranged on the circuit board, and the control switch is linked with the mechanical switch, and the control switch controls the circuit board to operate through the mechanical button when pressed. The battery pack 1107 is a rechargeable battery, and a charging port 1108 is arranged on the outer wall of the protruding device 1100, and the charging port 1108 is electrically connected with the battery pack 1107. This protruding device can be used in many fields, such as personal care, pet care, plant spraying, etc. This device is used for pet care, such as spraying water mist when grooming to moisten the hair and skin of pets. This can improve the comfort of pets and make the grooming process more enjoyable; because the protruding device 1100 offers portability, users can use it anytime and anywhere. This makes it an ideal choice for outdoor activities, travel and daily use.

The water storage cavity 1101 is made of a material with good sealing performance, so as to ensure that water leakage does not occur during carrying and use. This design is very important for the practicality of grooming gloves, because users don't want to encounter the problem of water mist leakage during use. The capacity of the water storage cavity 1101 is moderate, which can meet the water demand for one grooming process. In this way, users can finish grooming their pets without adding water frequently, and these materials have good water resistance and sealing performance. When designing the water storage cavity 1101, the user's experience is considered. The cover that is easy to open and close, the clean and convenient design and the transparent shell allow users to check the water quantity at any time, which are all factors worthy of consideration.

In this embodiment, the control chamber 1105 is isolated from the water storage cavity 1101 and located in a dry space to avoid damage caused by contact with liquid. Its size has been carefully designed to accommodate electronic components such as circuit board 1106 and battery pack 1107. The circuit board 1106 is the core of the power management system, which is responsible for receiving and processing instructions from the control switch and controlling the charging and discharging process of the battery. A variety of electronic components, such as microprocessors and sensors, are integrated on the circuit board to ensure the stable operation of the system. In order to ensure the tightness of the water storage cavity 1101, high-quality sealing materials, such as silica gel, rubber or special plastic, may be selected.

In this embodiment, the control switch 1111 adopts a rebound button switch, and the user can turn on or off the spraying part by pressing the switch. The rechargeable battery is the energy source of the carding gloves, which is responsible for providing stable electric energy for the circuit board 1106 and other electronic components. High-performance rechargeable batteries are used to ensure the continuous and stable operation of gloves. The charging port 1108 is located outside the control chamber 1105 for connecting an external charger to charge the rechargeable battery. A standard charging port design is adopted to be compatible with most chargers on the market. In this way, users can conveniently use the existing charging equipment.

The design of the control chamber 1105 effectively avoids the contact between the circuit board 1106 and liquid, thus improving the security of the system. Meanwhile, the safety protection mechanism on the circuit board 1106 can monitor the battery status. If the battery is overcharged or discharged, it will automatically cut off the power supply to prevent the circuit board and the battery from being damaged. This helps to prolong the life of the battery and improve the reliability of the system. The design of rechargeable battery makes it unnecessary for users to change the battery frequently, and only need to charge the battery through the charging port. This not only reduces the use cost, but also improves the convenience of use and reduces the maintenance cost.

In this embodiment, a water injection port 1110 which can be connected to a water pipe is embedded in the outer wall of the protruding device 1100, and the lower part of the water injection port 1110 is communicated with the water storage cavity 1101, and an openable cover 1112 is arranged above the water injection port 1110. The water storage cavity 1101 is provided with a water injection port 1110 for filling the water storage cavity 1101 with clean water or other suitable liquid. The design of the water injection port 1110 takes into account the user's usage habits, and adopts the structure of the cover 1112 which is easy to open and close, which makes the filling of liquid simple and quick. In addition, the water injection port 1110 is equipped with a leak-proof device to ensure that liquid will not leak during filling.

The design of the control switch 1111 takes into account the convenience and safety of users, adopts an easy-to-operate structure, and can be set with obvious signs to distinguish between open and closed states. By pressing the control switch 1111, the user can easily control the generation of water mist to meet different grooming requirements.

The present application further provides a novel grooming method, which comprises the following steps: providing an apparatus, which comprises a glove body 1000, wherein the glove body 1000 is provided with at least one cleaning surface 1200, and the cleaning surface 1200 is provided with a comb tooth part 1001;
the glove body 1000 is provided with a protruding device 1100, and the protruding device 1100 is provided with a spraying part for spraying the area facing the cleaning surface 1200; the protruding device 1100 is provided with a water storage cavity 1101 for supplying water to the spraying part, a circuit board 1106 for controlling the operation of the spraying part and a control switch 1111;
the method comprises the following steps:
wearing the glove body 1000, and using the cleaning surface 1200 on the glove body 1000 for cleaning;
turning on the spraying part through the control switch 1111 on the glove body 1000, by which the generation of water mist can be easily controlled to meet the grooming requirements;
grooming the area facing the cleaning surface 1200 with the comb teeth 1002 of the comb tooth parts 1001; in order to effectively remove the lumps and impurities in the pet's hair, promoting the blood circulation of the pet's skin and enhancing the comfort of the pet;
atomizing, humidifying and cleaning the area facing the cleaning surface 1200 by the spraying part, wherein the water mist generated by the atomizing component 1102 can moisten the hair and skin of the pet, effectively alleviating the discomfort of the pet during grooming.

Compared with directly spraying water and humidifying with a water spraying mechanism on the glove, the effect of spraying water mist is less irritating to pets, which reduces the possibility of pet stress reaction when cleaning and nursing pets, and the water mist will not make pet hair too wet and can be quickly dried after cleaning.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting. The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples

1. An animal bathing and grooming glove, comprising;
a glove body, wherein the glove body has a closed five finger structure and at least one cleaning surface provided with comb tooth parts, and the glove body has a hand back part opposite the at least one cleaning surface;
the glove body is provided with a protruding device, the protruding device is provided with a spraying part that has a spraying pipe for spraying an area facing the at least one cleaning surface; and
a water storage cavity for supplying water to the spraying part, a circuit board and a control switch for controlling operation of the spraying part are arranged in the protruding device,
wherein the spraying pipe is communicated with the water storage cavity and is disposed external of the glove body on the hand back part, the spraying pipe passes from the hand back part to the at least one cleaning surface through a space external of the glove body between two adjacent fingers of the five fingers.

2. The animal bathing and grooming glove according to claim 1, wherein the spraying part comprises an atomizing component, an end of the spraying pipe away from the water storage cavity is a spraying port, and the spraying port sprays to the area facing the at least one cleaning surface.

3. (canceled)

4. The animal bathing and grooming glove according to claim 2, wherein a water injection port constructed be connected with a water pipe is embedded in an outer wall of the protruding device, a lower part of the water injection port is communicated with the water storage cavity, and an openable and closable cover is arranged above the water injection port.

5. The animal bathing and grooming glove according to claim 1, wherein the comb tooth parts are integrally formed or detachably connected with the glove body, and a plurality of comb teeth are formed on the comb tooth parts.

6. The animal bathing and grooming glove according to claim 1, wherein the glove body comprises a palm part and a wrist part, the at least one cleaning surface is arranged on the palm part, and the protruding device is arranged on the hand back part.

7. The animal bathing and grooming glove according to claim 6, wherein a strap is arranged on the wrist part, the strap encircles the wrist part in one circle, and an end of the strap is provided with a hook and loop.

8. The animal bathing and grooming glove according to claim 6, wherein the comb tooth parts are arranged on a palm part area and a finger area of the palm part.

9. The animal bathing and grooming glove according to claim 6, wherein the protruding device is connected with the hand back part by an adhesive.

10. The animal bathing and grooming glove according to claim 1, wherein a control chamber is formed in the protruding device, the circuit board is arranged in the control chamber; the circuit board is electrically connected with the spraying part, and the control switch is embedded on the outer wall of the protruding device and controls the circuit board to operate.

11. An animal bathing and grooming glove, comprising:
a glove body, wherein the glove body has a closed five finger structure and at least one cleaning surface, and the glove body has a hand back part opposite the at least one cleaning surface, the at least one cleaning surface is provided with a comb tooth part with comb teeth and a spraying port, and the glove body is provided with a protruding device, wherein the protruding device is provided with a water storage cavity, a spraying part communicated with the water storage cavity, a battery pack for supplying energy to the spraying part, a circuit board and a control switch for controlling the operation of the spraying part; the spraying part has a spraying pipe communicated with the spraying port to form a spraying channel, the spraying pipe is disposed external of the glove body on the hand back part, the spraying pipe passes from the hand back part to the at least one cleaning surface through a space external of the glove body between two adjacent fingers of the five fingers; and
the spraying port sprays to an area facing the at least one cleaning surface;
the protruding device is provided with a water injection port constructed to be connected with a water pipe, and the water injection port is communicated with the water storage cavity.

12. The animal bathing and grooming glove according to claim 11, wherein the spraying part comprises an atomizing component that converts water in the water storage cavity into water mist and sprays the mist into the spraying pipe.

13. (canceled)

14. The animal bathing and grooming glove according to claim 11, wherein the glove body comprises a palm part and a wrist part, the at least one cleaning surface is arranged on the palm part, and the protruding device is arranged on the hand back part.

15. The animal bathing and grooming glove according to claim 14, wherein a strap is arranged on the wrist part, and the strap encircles the wrist part in one circle, and an end of the strap is provided with a hook and loop.

16. The animal bathing and grooming glove according to claim 14, wherein the protruding device is connected with the hand back part by an adhesive.

17. The animal bathing and grooming glove according to claim 11, wherein a control chamber is arranged in the protruding device, the battery pack and the circuit board are arranged in the control chamber, and the control switch is embedded on an outer wall of the protruding device and controls the circuit board to operate.

18. The animal bathing and grooming glove according to claim 11, wherein the water injection port is embedded on the outer wall of the protruding device, a lower part of the water injection port is communicated with the water storage cavity, and an openable and closable cover is arranged above the water injection port.

19. The animal bathing and grooming glove according to claim 17, wherein a charging port is arranged on the outer wall of the protruding device, and the charging port is electrically connected with the battery pack.

20. A grooming method, comprising the following steps:
providing an apparatus, which comprises a glove body, wherein the glove body is provided with a closed five finger structure and at least one cleaning surface, and a comb tooth part is arranged on the at least one cleaning surface, the glove body has a hand back part opposite the at least one cleaning surface;
the glove body is provided with a protruding device, and the protruding device is provided with a spraying part that has a spraying pipe for spraying an area facing the at least one cleaning surface; and
a water storage cavity for supplying water to the spraying part, a circuit board and a control switch for controlling the spraying part to work are arranged in the protruding device;
wherein the spraying pipe is communicated with the water storage cavity and is disposed external of the glove body on the hand back part, the spraying pipe passes from the hand back part to the at least one cleaning surface through a space external of the glove body between two adjacent fingers of the five fingers;
wherein the method further comprises the following steps:
wearing the glove body and choosing the at least one cleaning surface on the glove body for cleaning;
opening the spraying part through the control switch on the glove body;
grooming the area facing the at least one cleaning surface by the comb tooth part; and
atomizing, humidifying and cleaning the area facing the at least one cleaning surface by the spraying part.

21. The animal bathing and grooming glove according to claim 2, wherein the spraying port is disposed in the space external of the glove body between two adjacent fingers.

22. The animal bathing and grooming glove according to claim 11, wherein the spraying port is disposed in the space external of the glove body between two adjacent fingers.
